(19) United States
(12) Patent Application Publication
(10) Pub. No.: US 2008/0223079 A1
(43) Pub. Date: Sep. 18, 2008

(54) APPARATUS AND PROCESS FOR PRODUCING A FLOAT GLASS

(75) Inventors: Toru KAMIHORI, Tokyo (JP); Motoichi Iga, Tokyo (JP); Tetsushi Takiguchi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 12/124,662

(22) Filed: May 21, 2008

Related U.S. Application Data
(63) Continuation of application No. PCT/JP2006/321301, filed on Oct. 25, 2006.

(30) Foreign Application Priority Data
Nov. 25, 2005 (JP) 2005-340131

(51) Int. Cl. C03B 18/16; C03B 18/00

(52) U.S. Cl. 65/99.3; 65/182.3

(57) ABSTRACT

The purpose of the present invention is to provide an apparatus for producing a float glass capable of controlling a temperature rise in the bottom casing to prevent the bottom casing from being corroded by reaction with the molten metal released therefrom.

The bottom casing of a flat glass producing apparatus is comprised of a plurality of non-magnetic casing pieces that are electrically insulated from each other by means of a non-woven fabric of silica glass having non-affinity for tin whereby in comparison with a flat glass producing apparatus having the bottom casing of a united structure, an induced current can be controlled thereby prohibiting a temperature rise in the bottom casing. With such structure, tin penetrating in joint portions of the bottom bricks can be prevented from melting and the corrosion of the bottom casing by reaction with the released molten tin can be prevented.

### TECHNICAL FIELD

The present invention relates to an apparatus for producing a float glass by a float method and a process for producing the same.

### BACKGROUND ART

An apparatus for producing a flat glass with use of a float method is such one that molten glass is supplied successively onto a molten metal such as molten tin filled in a tank and is advanced on the molten metal in a floating state to form a molten glass ribbon, and when it has reached or is about to reach an equilibrium thickness (about 6 to 7 mm) according to a balance of its surface tension and the gravity or it has a thickness of more than the equilibrium thickness, the molten glass ribbon is pulled toward an annealing lehr which is adjacent to an outlet of the tank, so that a strip-like glass sheet having a predetermined width is produced.

In this case, it is impossible to form a thin flat glass for a liquid crystal device such as a flat glass for FPD (Flat Panel Display) having a sufficient thickness of, for example, from 0.1 to 1.1 mm if one takes measures of pulling simply the molten glass ribbon on the molten metal toward the annealing lehr.

For this, in the manufacturing apparatus disclosed in Patent Document 1, a molten glass ribbon is formed into a predetermined thin glass sheet by forming recessed portions in the bath surface of the molten metal at locations along the side edges of the molten glass ribbon so that the both edges fit into the recessed portions so as to be retained there, whereby a force against a contractive force of the molten glass ribbon in its width direction can be retained. This manufacturing apparatus is provided with linear motors as means for forming the recessed portions in the bath surface of the molten metal. These linear motors are located under the tank. Accordingly, moving magnetic fields by these linear motors act on the molten metal so that the bath surface of the molten metal is sucked in a substantially vertical direction whereby the recessed portions are formed.

Patent Document: JP-A-10-236832

### DISCLOSURE OF THE INVENTION

### Problem to be Solved by the Invention

In the conventional float glass manufacturing apparatus, as described in Patent Document 1, employing the linear motors to generate moving magnetic fields so as to act on the molten metal, the furnace plate of the tank is composed of bricks (hereinbelow, referred to as the bottom bricks). Further, in order to assure air-tightness, it is necessary to use a metallic casing for covering a lower surface of the bottom bricks (hereinbelow, referred to as the bottom casing).

However, in the float glass manufacturing apparatus having the above-mentioned structure, there was a possibility that the molten metal in the tank leaks from the bottom casing. The cause of the leakage is explained as follows. Since the manufacturing apparatus is so constructed that the moving magnetic fields by the linear motors act on the molten metal via the bottom casing and the bottom bricks, an induced current generates in the metallic bottom casing, and the bottom casing generates heat due to Joule heat to thereby cause temperature rise in it. When the temperature of the bottom casing elevates, molten metal penetrating in joint portions between bottom bricks is heated, dissolved and released therefrom. The released molten metal contacts the bottom casing and reacts therewith, whereby it corrodes the bottom casing.

Thus, the molten metal in the tank, releasing from the joint portions of the bottom bricks leaks through the corroded portion of the bottom casing. For example, when molten tin is employed as the molten metal, the melting point of tin is about 232° C. The tin heated further by Joule heat generated in the bottom casing corrodes the bottom casing.

A bottom casing made of a non-magnetic material can control the generation of an induced current in comparison with that of a magnetic material. However, this technique cannot greatly contribute to the reduction of such Joule heat. Further, it can be considered to lower a current for a linear motor in order to control the induced current. In this case, however, a lower moving magnetic field is produced and accordingly, a driving force to the molten metal is lowered, so that a preferred recessed portion may not be formed in the bath surface of the molten metal.

The present invention is, in view of the above-mentioned circumstances, to provide an apparatus and a process for producing a float glass, capable of preventing the bottom casing from being corroded by controlling a temperature rise in the bottom casing.

### Means to Accomplish the Object

In a first embodiment of the present invention, there is provided an apparatus for producing a float glass having a tank filled with a molten metal, bottom bricks constituting a furnace plate for the tank, a bottom casing provided at a lower part of the bottom bricks to cover them and a linear motor provided below the bottom casing to drive the molten metal by the action of a magnetic field, said apparatus being characterized in that at least the area subject to the action of a moving magnetic field by the linear motor, of the bottom casing is made of a non-magnetic material, and this bottom casing has a cooling structure, in order to achieve the above-mentioned object.

According to the first embodiment, the bottom casing of non-magnetic material provided at least the area subject to the action of a moving magnetic field by the linear motor has a cooling structure by which the bottom casing is cooled. Accordingly, the temperature rise of the bottom casing due to Joule heat can be controlled without lowering the power of the linear motor. With this, metal penetrating in joint portions of bottom bricks can be prevented from melting and the corrosion of the bottom casing by reaction with the molten metal released from the joint portions can be prevented. The cooling structure includes general cooling means such as an air-cooled type for blowing directly cooling air to the bottom casing, a water-cooled type or the like.

In a second embodiment of the present invention, there is provided the apparatus for producing a float glass according to the first embodiment, wherein the cooling structure is a water-cooled structure.

The cooling structure is of a water cooled type in which conduits are formed in the bottom casing and can be realized by feeding cooling water to these conduits with use of, for example, a pressurized-water circulation system. Since this cooling structure can cool directly the bottom casing, a high cooling efficiency is obtainable. Further, this cooling structure can also be realized by providing a water jacket on the wall surface of the bottom casing.

In a third embodiment of the present invention, there is provided an apparatus for producing a float glass having a tank filled with a molten metal, bottom bricks constituting a furnace plate for the tank, a bottom casing provided at a lower part of the bottom bricks to cover them and a linear motor provided below the bottom casing to drive the molten metal by the action of a magnetic field, said apparatus being characterized in that at least the area subject to the action of a moving magnetic field by the linear motor, of the bottom casing is comprised of a plurality of non-magnetic casing pieces which are electrically insulated from each other by means of an insulation material, in order to achieve the above-mentioned object.

According to the third embodiment, the bottom casing in at least the area subject to the action of a moving magnetic field by the linear motor is constituted by a plurality of non-magnetic casing pieces which are electrically insulated from each other by means of an insulation material such a non-woven fabric of silica glass having non-affinity for, for example, tin. Accordingly, an induced current can be controlled in comparison with the apparatus having the bottom casing comprising a casing member of a united structure. Accordingly, the temperature rise of the bottom casing can be controlled without lowering the power of the linear motor. With this, the metal penetrating in joint portions of bottom bricks can be prevented from melting and the corrosion of the bottom casing by reaction with the molten metal released from the joint portions can be prevented. Further, a loss due to an induced current in the bottom casing can be reduced in this embodiment of the present invention, whereby the intensity of a moving magnetic field to the molten metal can be increased and the driving force to the molten metal can be improved, so that a preferred recessed portion can be formed in the bath surface of the molten metal.

In the conventional apparatus, since a large induced current was produced in the bottom casing, there was a limitation to the current for the linear motor. In the present invention, however, the current for the linear motor can be increased by reducing the induced current to the bottom casing, and therefore, the driving force to the molten metal can further be increased whereby a further preferred recessed portion can be formed in the bath surface of the molten glass.

In a fourth embodiment of the present invention, there is provided the apparatus according to the above-mentioned third embodiment, wherein each of the casing pieces has a reed-shaped body having dimensions of W≦2 τ where W (mm) represents a dimension of a short side and τ (mm) represents the pole pitch of the linear motor, and the casing pieces are arranged so that their long sides are substantially in parallel to a moving direction of the magnetic field by the linear motor. The pole pitch of the linear motor indicates a half wavelength (the length of a half cycle) of a magnetic flux density procured by feeding an A.C. current in a linear motor (p. 56 “Industrial Linear Motors” described by Hajime Yamada, published by Kabushiki Kaisha Kogyo Chousakai).

Since there is approximately proportional relationship between the dimension of a short side (W) of a casing piece and the calorific value (kW) of the casing, the calorific value can be controlled by reducing the dimension of the short side.

According to the fourth embodiment, when W (mm) stands for the dimension of a short side of a reed-shaped casing piece and τ (mm) stands for the pole pitch of a linear motor, W≦2 τ is established. Further since the casing pieces are arranged so that their long sides are substantially in parallel to a moving direction of the magnetic field by the linear motor, it is possible to control sufficiently the induced current in the bottom casing. In consideration of the strength of the bottom casing and workability, it is preferred to set it to W≧80 mm.

In a fifth embodiment of the present invention, there is provided an apparatus for producing a float glass having a tank filled with a molten metal, bottom bricks constituting a furnace plate for the tank, a bottom casing provided at a lower part of the bottom bricks to cover them and a linear motor provided below the bottom casing to drive the molten metal by the action of a moving magnetic field, said apparatus being characterized in that at least the area subject to the action of a moving magnetic field by the linear motor, of the bottom casing is comprised of a plurality of non-magnetic casing pieces of stainless steel which have cooling structures comprising water-cooling pipes and are electrically insulated from each other by means of an insulation material, in order to achieve the above-mentioned object.

According to the fifth embodiment, the bottom casing in at least the area subject to the action of a moving magnetic field by the linear motor has a cooling structure comprising conduits to cool the area directly, and is constituted by a plurality of non-magnetic casing pieces of stainless steel which are electrically insulated from each other by means of an insulation material composed mainly of a silica cloth having non-affinity for tin. With such structure, an induced current produced in the bottom casing can be controlled whereby the metal penetrating in joint portions of bottom bricks can be prevented from melting and the corrosion of the bottom casing by reaction with the molten metal released from the joint portions can be prevented.

In a sixth embodiment of the present invention, there is provided the apparatus according to the above-mentioned fifth embodiment, wherein each of the casing pieces has a reed-shaped body having dimensions of W≦2 τ where W (mm) represents a dimension of a short side and t (mm) represents the pole pitch of the linear motor, and the casing pieces are arranged so that their long sides are substantially in parallel to a moving direction of the magnetic field by the linear motor. Thus, an induced current produced in the bottom casing can sufficiently be controlled.

In a seventh embodiment of the present invention, there is provided a process for producing a float glass characterized in that a float glass is produced by using an apparatus for producing a float glass described in the above-mentioned embodiments, in order to achieve the above-mentioned object.

### EFFECTS OF THE INVENTION

According to the apparatus and the process for producing a float glass of the present invention, a temperature rise in the bottom casing due to Joule heat can be controlled without lowering the power of the linear motor. Accordingly, the metal penetrating in joint portions of bottom bricks can be prevented from melting and the corrosion of the bottom casing by reaction with the molten metal released from the joint portions can be prevented.

### BRIEF DESCRIPTION OF THE DRAWINGS

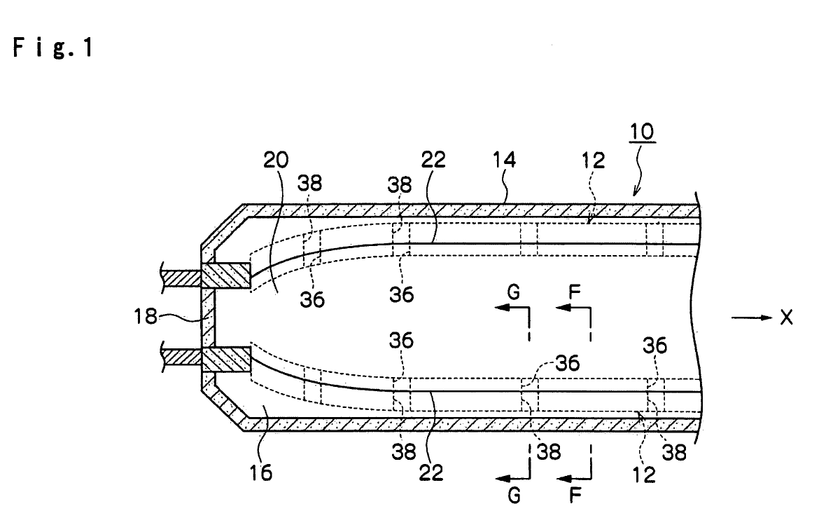

(FIG. 1) A plan view showing an apparatus for producing a flat glass according to an embodiment of the present invention.

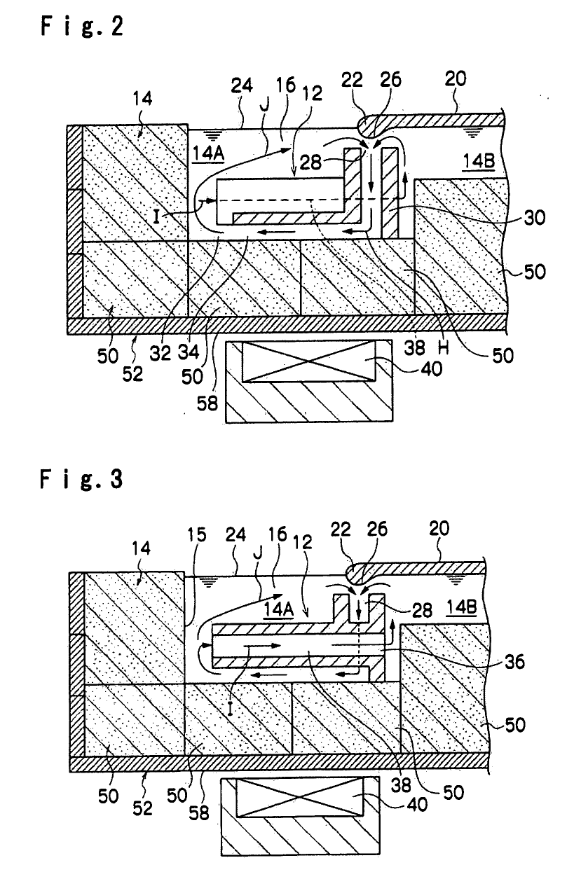

(FIG. 2) A cross-sectional view of the gutter-like member viewed from a line F-F in FIG. 1.

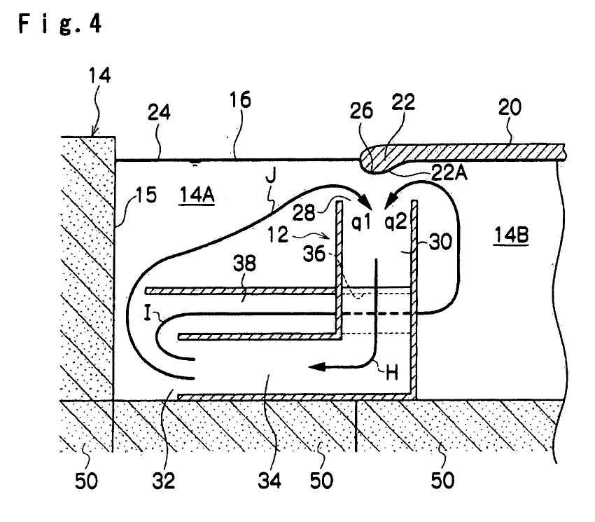

(FIG. 3) A cross-sectional view of the gutter-like member viewed from a line G-G in FIG. 1.

(FIG. 4) An enlarged cross-sectional view of the gutter-like member shown in FIG. 2 or FIG. 3.

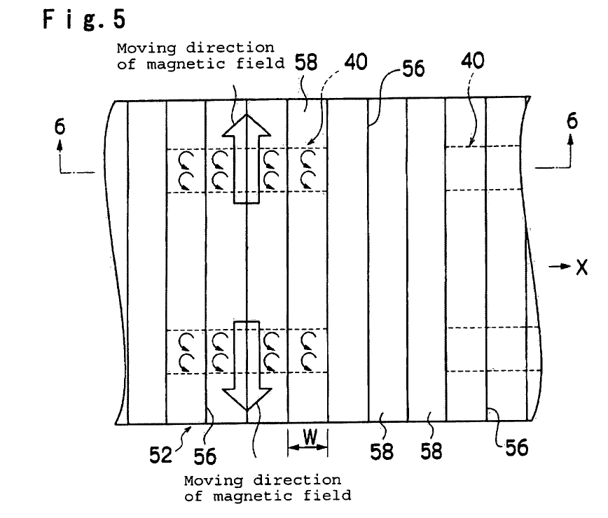

(FIG. 5) A plan view of relevant part of the bottom casing.

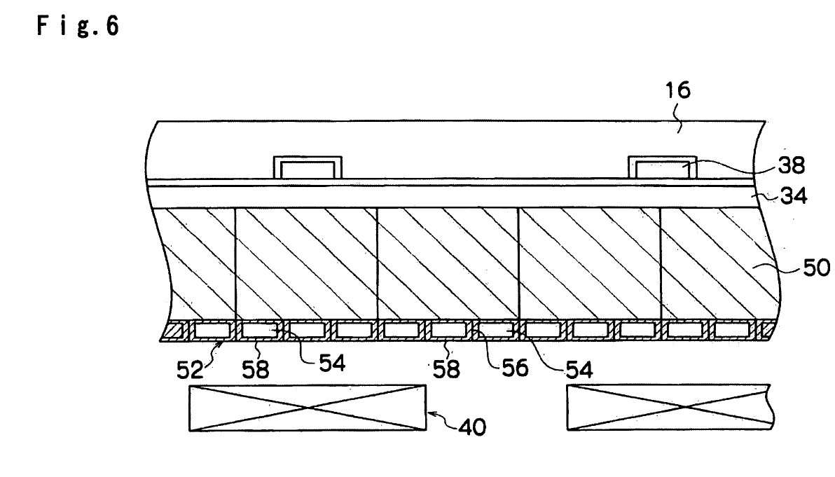

(FIG. 6) A cross-sectional view along a line 6-6 in FIG. 5.

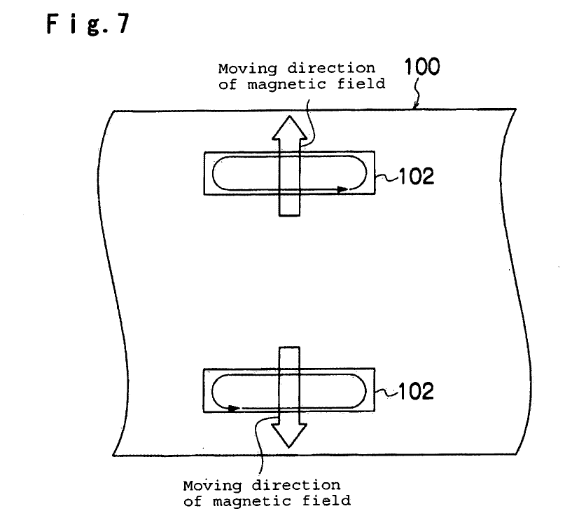

(FIG. 7) A plan view of relevant part in the structure of a conventional bottom casing.

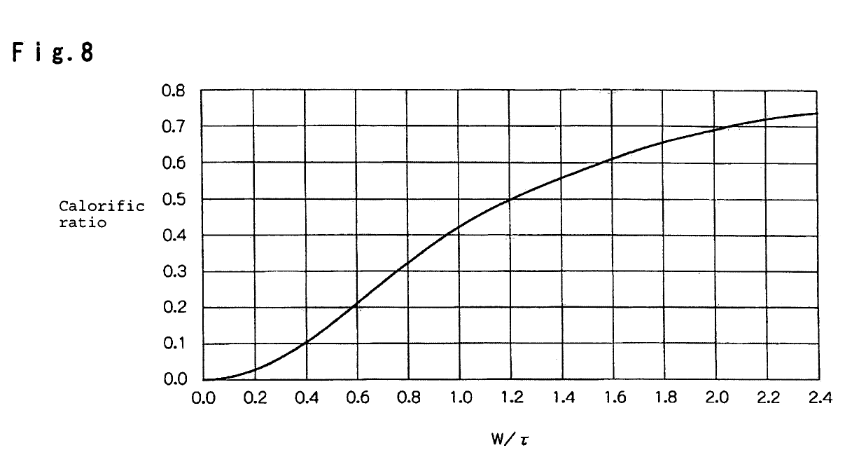

(FIG. 8) A graph showing the relation in calorific ratio of W/τ.

### MEANINGS OF SYMBOLS

10: Flat glass manufacturing apparatus, 12: gutter-like member, 14: tank, 16: molten tin, 18: supply port, 20: molten glass ribbon, 22: edge, 24: bath surface, 26: recessed portion, 28: inlet port, 30: longitudinal passage, 32: outlet port, 34: lateral passage, 36: through-hole, 38: circulation passage, 40: linear motor, 50: bottom brick, 52: bottom casing, 54: conduit, 56: non-woven fabric, 58: casing piece

### BEST MODE FOR CARRYING OUT THE INVENTION

In the following, description will be made as to preferred embodiments of an apparatus and a process for producing a float glass according to the present invention, with reference to attached drawing.

FIG. 1 is a plan view of a flat glass manufacturing apparatus 10 for producing a flat glass using a float method. A flat glass used for FPD, for example, a flat glass for a liquid crystal device, is generally required to have a sheet thickness of from about 0.1 to 1.1 mm, and also, is required to have a high precision in flatness. For the flat glass manufacturing apparatus 10, an apparatus equipped with gutter-like members 12 is employed. With such flat glass manufacturing apparatus 10, a flat glass satisfying a sheet thickness and flatness required for a flat glass for FPD can be produced.

The gutter-like members 12 of the flat glass manufacturing apparatus 10 are disposed in a tank 14 to be dipped in molten tin (molten metal) 16 received in the tank 14 and are disposed along both side edges 22, 22 of a molten glass ribbon 20 supplied continuously from a molten glass furnace through a supply port 18 to the tank 14. The molten glass ribbon 20 is advanced by a pulling force in the direction of an annealing lehr (a direction of X in FIG. 1) on the bath surface of the molten tin 16 while the edges 22, 22 are retained at recessed portions 26 (FIG. 2) formed in the bath surface 24, whereby a force against a contractive force of the molten glass ribbon 20 in its width direction can be retained. The molten glass ribbon 20 whose edges 22 are retained by the recessed portions 26 is subjected to adjustments to the thickness and the width, and then, is fed in a stable state to a rear part of the tank while it is supplied to the annealing lehr for cooling.

Glass used in this embodiment is non-alkali glass, sodalime glass or the like. The molten tin 16 and the glass ribbon 20 are heated to 800 to 1,300° C. with electrical heaters (not shown).

FIG. 2 is a cross-sectional view taken along a line F-F in FIG. 1, and FIG. 3 is a cross-sectional view taken along a line G-G in FIG. 1. In these Figures, each of the gutter-like members 12 is formed to have a substantially L-like shape in cross section and comprises a longitudinal passage 30 with an inlet port 28, a lateral passage 34 (FIG. 2) with an outlet port 32 and a circulation passage 38 (FIG. 3) with a through-hole 36 at a position corresponding to the longitudinal passage 30.

A linear motor 40 is located below the bottom portion of the tank 14 so as to correspond to a lateral passage 34 of a gutter-like member 12. By the action of a moving magnetic field produced by the linear motor 40, a driving force is given to the molten tin 16 in the lateral passage 34 so that the molten tin 16 is driven in the direction indicated by an arrow mark H in the longitudinal passage 30 and the lateral passage 34 of the gutter-like member 12.

By this movement, a flow of the molten tin 16 is created in a direction substantially perpendicular to the bath surface 24 toward the bottom of the tank 14. Accordingly, a negative pressure is produced below the edge 22 of the molten glass ribbon 20 so that the level of the bath surface of the molten tin 16 at that edge 22 is lower than the bath surface level around the edge 22. Then, an edge portion 22 of the molten glass ribbon 20 fits into the recessed portion 26 of the bath surface 24 lowered by the negative pressure. Since the edge 22 of the molten glass ribbon 20 is retained by this recessed portion 26, a molten glass ribbon having a predetermined width can be formed. Thus, by pulling the molten glass ribbon in the direction of the annealing lehr while the dimension of the ribbon in its width direction is retained, a flat glass having a thinner sheet thickness than an equilibrium thickness (a thickness of from 0.1 to 1.1 mm) can be produced.

The material of the gutter-like member 12 may be of low reactivity or non reactivity with the molten tin 16 or of high-temperature-tolerant, such as alumina, silimanite, clayish brick or carbon. In this embodiment using the linear motor 40, carbon is employed since it is necessary for the gutter-like member 12 to be made of a non-magnetic substance so as to exert a magnetic field to the gutter-like member 12 and the carbon has good workability because a large-sized gutter-like member is employed.

The linear motor 40 has advantages that the molten tin 16 can be driven directly in a non-contact state and it is easy to control the flow rate. The linear motor 40 generates a magnetic field moving in a certain direction by applying an A.C. voltage to the coils wound around a comb-like primary iron core and by magnetizing sequentially these coils. This linear motor 40 is located below the bottom bricks 50, 50 constituting the tank 14 in which the gutter-like members are disposed and the bottom casing 52 covering these bottom bricks 50, 50 . . . , at a position that a driving force (an urging force) acts on the molten tin 16 in the lateral passage 34 of the gutter-like member 12. With such structure, the molten tin 16 in the longitudinal passage 30 and the lateral passage 34 flows from the area just below the edge 22 of the molten glass ribbon 20 toward a side wall 15 of the tank 14 as indicated by the arrow mark H, due to the driving force of the linear motor 40. The bottom casing 52 will be described later.

The gutter-like member 12 has a circulation passage 38 other than the longitudinal passage 30 and the lateral passage 34. This circulation passage 38 is communicated with a portion 14B, which is on the side of the center of the tank with respect to the edge 22 of the molten glass ribbon 20, via a through-hole 36 formed at a position corresponding to the longitudinal passage 30. Therefore, an edge portion 14A of the tank is communicated with the portion 14B on the side of the center of the bath via the circulation passage 38 and the through-hole 36. Accordingly, the molten tin 16 flowing from the outlet port 32 of the lateral passage 34 and being deflected by the side wall 15 of the tank 14 is partly introduced into the circulation passage 38 as indicated by an arrow mark I so as to be introduced to the portion 14B at a side of the center of the tank via the through-hole 36, as shown in FIGS. 2 and 3. The remaining part of the molten tin 16 flows to the edge portion 14A of the tank as indicated by an arrow mark J to be sucked into the inlet port 28 of the longitudinal passage 30.

As shown by broken lines in FIG. 1, there are a plurality of circulation passages 38 formed with predetermined distances in the direction of flow of the molten glass ribbon 20. The distance between adjacent circulation passages 38 is determined not only to prevent the occurrence of disturbance of the molten tin to be sucked at the inlet port 28 of the longitudinal passage 30 and to affect little influence on the recessed shape of the recessed portion 26 but also to render optimally the balance between the low rate of the molten tin flowing into the inlet port 28 of the longitudinal passage 30 from the edge portion 14A of the tank and the flow rate of the molten tin flowing into the inlet port 28 from the portion 14B at the side of the center of the tank, so as to be substantially uniform over the entire length of the passage and to assure the retention of the edge portions. The circulation passages can be formed with intervals of, for example, from 0.3 to 1 m.

Control of the flow rate of the molten tin 16 may be determined previously before the operation of the flat glass manufacturing apparatus 10 or may be determined while the flat glass is produced after the initiation of the operation thereof.

On the gutter-like member 12, it is so constructed that a part of molten tin in the molten tin 16 flowing from the outlet port 32 of a lateral passage 34 of the gutter-like member 12 to the edge portion 14A of the tank is introduced to the portion 14B at the side of the center of the tank via the circulation passage 38 and the through-hole 36 due to a sucking force generated at the inlet port 28, and then is sucked into the inlet port 28. Accordingly, the flow quantity q1 of the molten tin 16 flowing from the edge portion 14A of the tank to the inlet port 28 is balanced with the flow quantity q2 of the molten tin 16 flowing from the portion 14B at the side of the center of the tank to the inlet port 28, as shown in FIG. 4. In other words, the both flow quantities q1, q2 of the molten tin are substantially equal in the advancing direction of the molten glass ribbon 20, and recessed portions 26 suitable for retaining the edges of the ribbon are formed substantially uniformly in the bath surface 24 over the entire length of the gutter-like members 12 along the advancing direction of the molten glass ribbon 20, whereby the edges 22 of the molten glass ribbon can be retained stably in their entire lengths by the recessed portions 26. With this, it is possible to produce a flat glass satisfying a sheet thickness and flatness required for FPD.

There is a case that different temperatures are set for predetermined sections arranged along the flowing direction of the molten glass ribbon 20. In this case, at least one circulation passage 38 should be provided at a position corresponding to each section, whereby temperature distributions for these sections can be maintained as desired so that flat glass of stable quality can be produced.

In order to exert a moving magnetic field by the linear motor 40 to the molten tin 16, the bottom casing 52 of this embodiment is so constructed that at least the area subject to the action of a moving magnetic field of the linear motor 40 is made of an austenite type stainless steel as a non-magnetic material. Further, in the bottom casing 52 of this area, conduits 54, 54 . . . (see FIG. 6) are formed as a cooling structure. Accordingly, the bottom casing 52 is cooled by feeding cooling water in these conduits 54, 54 . . . by employing, for example, a pressurized-water circulation system. Thus, the cooling structure in the bottom casing 52 can cool easily the bottom casing 52 whereby the temperature rise of the bottom casing 52 due to Joule heat can be controlled without lowering the power of the linear motor 40. Accordingly, the tin penetrating in joint portions of bottom bricks 50, 50 . . . can be prevented from melting and the corrosion of the bottom casing 52 by reaction with the molten tin released from the joint portions can be prevented. Further, since this cooling structure cools directly the bottom casing 52, a high cooling efficiency is obtainable. The cooling structure may be provided in the bottom casing 52 or may be provided on the surface of the bottom casing 52.

At least the area subject to the action of a moving magnetic field of the linear motor 40, of the bottom casing 52 of this embodiment is constituted by arranging a plurality of casing pieces 58, 58 . . . of austenite type stainless steel that are insulated electrically from each other by a non-woven fabric (an insulation material) 56 composed mainly of silica glass fibers having non-affinity for tin as shown in FIG. 5 and FIG. 6. Accordingly, an induced current produced in this bottom casing can be controlled in comparison with a bottom casing 100 comprising a casing member of a united structure as shown in FIG. 7, and therefore, a temperature rise in the bottom casing 52 shown in FIG. 6 can be controlled, whereby the tin penetrating in joint portions of bottom bricks 50 can be prevented from melting and the corrosion of the bottom casing 52 by reaction with the molten tin released from the joint portions can be prevented. Further, in the present invention, a loss due to an induced current can be reduced and the driving force to the molten tin 16 is improved. In this embodiment, a conduit 54 is formed in each casing piece 58 located above a linear motor 40.

In the bottom casing 100 composed of a casing member of a united structure shown in FIG. 7, a large induced current generates, and therefore, there was a limitation in a current to the linear motor 102. On the other hand, in the bottom casing 52 of this embodiment, a current to the linear motor 40 can be increased by the reduction of the induced current in the bottom casing (see FIG. 5 and FIG. 6), and the driving force to the molten tin can further be increased. Even though the power of the linear motor 40 is lowered to a certain extent, a driving force of the same level of that in the conventional apparatus can be obtained. Accordingly, energy can be saved.

Further, a reed-shaped casing piece 58 is so formed that the dimension of its short side satisfies a relation of W≦2 τ, as shown in FIG. 5, where W (mm) represents a dimension of a short side and τ (mm) represents the pole pitch of the linear motor 40, whereby the induced current can be controlled sufficiently. Each casing piece 58 has a reed-shaped body in its approximate shape, and casing pieces are arranged so that their long sides are substantially in parallel to a moving direction of the magnetic field by a linear motor 40, as indicated by a thick arrow mark in FIG. 5.

A dimension of short side (W) of a casing piece 58 and a calorific value (kW) in the casing 58 by the linear motor 40 establish an approximately proportional relation. Accordingly, it is advantageous that the calorific value (kW) can be reduced as the dimension (W) of the short side is made smaller. However, the strength of and workability for the bottom casing 52 become low as the dimension (W) of the short side is made smaller. Accordingly, it is preferred that the dimension of the short side of the casing piece 58 is W≧80 mm.

FIG. 8 is a graph showing a relation of a calorific ratio of the dimension (W) of the short side to the pole pitch (τ) wherein in this calorific ratio, the calorific value in the conventional bottom casing of a united structure is represented as 1.

In a case of W/τ≦2 in the graph of FIG. 8, it is possible to control the calorific value to not more than 70% in comparison with that in the conventional apparatus. The relation is preferably W/τ≦1, more preferably W/τ≦0.5 and further preferably W/τ≦0.3. Here, in consideration of the strength of and workability for the bottom casing 52, W is preferably from 80 to 150 mm, more preferably from 90 to 110 mm. When W=100 mm and τ=348 mm for example, the calorific ratio is about 6% in comparison with that of the conventional bottom casing of a united type. Further, when W=100 mm and τ=261 mm, it is about 10%. As described above, the calorific value of the bottom casing 52 can be controlled substantially. The thickness of a sheet material for the casing piece 58 is preferably from 3 to 10 mm.

In the flat glass manufacturing apparatus 10 of this embodiment, a cooling structure having conduits 54 is provided in the bottom casing 52 composed of a plurality of casing pieces 58, 58 . . . . However, the cooling structure and the structure comprising a plurality of casing pieces 58 may be formed separately. Such structure can also provide the same effect that the metal penetrating in joint portions of bottom bricks can be prevented from melting and the corrosion of the bottom casing by reaction with the molten tin released from the joint portions can be prevented.

As described above, there is shown an embodiment of the flat glass manufacturing apparatus 10 wherein recessed portions 26 are formed in the bath surface 24 of the molten tin 16 by the action of a magnetic field by a linear motor 40 so that the both side edges 22, 22 of the molten glass ribbon 20 fit into the recessed portions 26. However, it is not limited to such structure. Namely, the float glass manufacturing apparatus of the present invention may be used as long as it utilizes a float method with use of a tank filled with molten tin and is provided with a linear motor below the bottom casing. However, in order to produce stably a flat glass having a sufficient sheet thickness and flatness required for a flat glass for FPD, it is preferred to employ the above-mentioned flat glass manufacturing apparatus 10 which can retain both edge portions 22, 22 by fitting the both edge portions in the recessed portions 26.

### INDUSTRIAL APPLICABILITY

The present invention can be employed for a float glass manufacturing apparatus adapted so that a moving magnetic field by a linear motor is exerted to a molten metal in the tank to form a molten glass ribbon by retaining edge portions of the ribbon, and it is especially suitable for producing a thin flat glass.

The entire disclosure of Japanese Patent Application No. 2005-340131 filed on Nov. 25, 2005 including specification, claims, drawings and summary is incorporated herein by reference in its entirety.

What is claimed is:

1. An apparatus for producing a float glass having a tank filled with a molten metal, bottom bricks constituting a furnace plate for the tank, a bottom casing provided at a lower part of the bottom bricks to cover them and a linear motor provided below the bottom casing to drive the molten metal by the action of a magnetic field, said apparatus being characterized in that at least the area subject to the action of a moving magnetic field by the linear motor, of the bottom casing is made of a bottom casing of non-magnetic material, and this bottom casing has a cooling structure.

2. The apparatus for producing a float glass according to claim 1, wherein the cooling structure is a water-cooled structure.

3. An apparatus for producing a float glass having a tank filled with a molten metal, bottom bricks constituting a furnace plate for the tank, a bottom casing provided at a lower part of the bottom bricks to cover them and a linear motor provided below the bottom casing to drive the molten metal by the action of a magnetic field, said apparatus being characterized in that at least the area subject to the action of a moving magnetic field by the linear motor, of the bottom casing is comprised of a plurality of non-magnetic casing pieces which are electrically insulated from each other by means of an insulation material.

4. The apparatus for producing a float glass according to claim 3, wherein each of the casing pieces has a reed-shaped body having dimensions of W≦2 τ where W (mm) represents a dimension of a short side and τ (mm) represents the pole pitch of the linear motor, and the casing pieces are arranged so that their long sides are substantially in parallel to a moving direction of the magnetic field by the linear motor.

5. An apparatus for producing a float glass having a tank filled with a molten metal, bottom bricks constituting a furnace plate for the tank, a bottom casing provided at a lower part of the bottom bricks to cover them and a linear motor provided below the bottom casing to drive the molten metal by the action of a moving magnetic field, said apparatus being characterized in that at least the area subject to the action of a moving magnetic field by the linear motor, of the bottom casing is comprised of a plurality of non-magnetic casing pieces of stainless steel which have cooling structures comprising water-cooling pipes and are electrically insulated from each other by means of an insulation material.

6. The apparatus for producing a float glass according to claim 5, wherein each of the casing pieces has a reed-shaped body having dimensions of W≦2 τ where W (mm) represents a dimension of a short side and τ (mm) represents the pole pitch of the linear motor, and the casing pieces are arranged so that their long sides are substantially in parallel to a moving direction of the magnetic field by the linear motor.

7. A process for producing a float glass characterized in that a float glass is produced by using an apparatus for producing a float glass described in claim 1.

8. A process for producing a float glass characterized in that a float glass is produced by using an apparatus for producing a float glass described in claim 3.

9. A process for producing a float glass characterized in that a float glass is produced by using an apparatus for producing a float glass described in claim 5.
